(19) United States
(12) Patent Application Publication
(10) Pub. No.: US 2024/0343477 A1
(43) Pub. Date: Oct. 17, 2024

(54) Diaper disposal system and device

(71) Applicant: Clay Mitchell Lineberger, Lakeland, Fl (US)

(72) Inventor: Clay Mitchell Lineberger, Lakeland, Fl (US)

(21) Appl. No.: 18/133,697

(22) Filed: Apr. 12, 2023

(51) Int. Cl. B65F 1/10; B65F 1/00; B65F 1/16

(52) U.S. Cl. CPC B65F 1/10; B65F 1/0093; B65F 1/16; B65F 2210/135; B65F 2210/181; B65F 2240/132

(57) ABSTRACT

A diaper disposal system includes a diaper disposal container, including a container body and a slidable lid held by guide rails; a window panel; a disposal container support member with attachment points; a diaper disposal device, including an angled chute, handles, a pivotable; and a connecting chute; such that the diaper disposal device is mountable in a window opening of a building, such that an entry aperture of the diaper disposal device is exposed in an interior of the building, such that a diaper is disposable into the diaper disposal device, such that the diaper falls through the angled chute and the connecting chute, and into the diaper disposal container outside the building.

### CROSS-REFERENCE TO RELATED APPLICATIONS

N/A.

### FIELD OF THE INVENTION

The present invention relates generally to the field of waste disposal systems for installation in commercial and residential building, and more particularly to methods and systems for disposal of diapers.

### BACKGROUND OF THE INVENTION

A variety of diaper pails are available for use in the home for the disposal of soiled diapers or other waste such as food scraps for composting, etc. Conventional diaper pails claim to lock-in and neutralize odors, and allow for disposing of large amounts of soiled diapers.

However, some conventional disposal systems may not be effective at one or more of those functions. Users may need to employ various methods to neutralize bad odor. Additionally, many diaper disposal pails have lids that are pivotally mounted on the pail and employ foot pedal actuators to open them. Therefore, using this mechanism repeatedly may cause alignment or mechanical failure causing the lid to get stuck. Further, conventional diaper disposal pails require special diaper pail bags that are refilled periodically and add to the cost of using a diaper pail.

As such, considering the foregoing, it may be appreciated that there continues to be a need for novel and improved devices and methods for disposing of large amounts of soiled diapers.

### SUMMARY OF THE INVENTION

The foregoing needs are met, to a great extent, by the present invention, wherein in aspects of this invention, enhancements are provided to the existing model of devices and methods for disposing of large amounts of soiled diapers.

In an aspect, a diaper disposal system can include:
a) a diaper disposal container, which can be configured to be positioned in an exterior of a building;
b) a diaper disposal device, which can include:
   an angled chute; and
c) a connecting chute, which is connected between an exit aperture of the angled chute and an entry aperture of the diaper disposal container;
wherein an inner portion of the diaper disposal device is configured to be mounted in a window opening of a window assembly in a wall of the building, such that the entry aperture of the diaper disposal device is exposed in an interior of the building, such that a diaper is disposable into the entry aperture of the diaper disposal device, whereby the diaper falls through the angled chute and the connecting chute, and into the diaper disposal container.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a schematic diagram showing a side view of a diaper disposal system, according to an embodiment of the invention.

FIG. 1B is a front perspective view of a diaper disposal device, according to an embodiment of the invention.

FIG. 1C is a rear perspective view of a diaper disposal device, according to an embodiment of the invention.

FIG. 1D is a right side view of a diaper disposal device, according to an embodiment of the invention.

FIG. 1E is a bottom view of a diaper disposal device, according to an embodiment of the invention.

FIG. 1F is a rear view of a diaper disposal device, according to an embodiment of the invention.

FIG. 1G is a front view of a diaper disposal device, according to an embodiment of the invention.

FIG. 1H is a front view of an angled chute, according to an embodiment of the invention.

FIG. 1I is a rear top perspective exploded view of a diaper disposal device, according to an embodiment of the invention.

FIG. 1J is a front bottom perspective exploded view of a diaper disposal device, according to an embodiment of the invention.

FIG. 2A is a front outer side view of a diaper disposal system, according to an embodiment of the invention.

FIG. 2B is a front outer side exploded view of a diaper disposal system, according to an embodiment of the invention.

FIG. 3 is a front outer side view of a diaper disposal system mounted in a second-story window, according to an embodiment of the invention.

FIG. 4 is a schematic diagram showing a side view of a diaper disposal system with a disposal bag and a flower box concealment structure, according to an embodiment of the invention.

FIG. 5 is a is an exterior front view of a flower box concealment structure, according to an embodiment of the invention.

FIG. 6A is a schematic diagram showing a side view of an example diaper disposal system with disposal container support, according to an embodiment of the invention.

FIG. 6B is a schematic diagram showing a front view of a disposal container support member, according to an embodiment of the invention.

FIG. 7A is a schematic diagram showing a side view of a diaper disposal system with a removable disposal container, according to an embodiment of the invention.

FIG. 7B is a schematic diagram showing a slidable lid on a top of a disposal container, according to an embodiment of the invention.

FIG. 8 is a schematic diagram showing a side view of a diaper disposal system with a removable disposal container in accordance with some implementations.

FIG. 9 is a schematic diagram showing a diaper disposal system installed in a horizontal sliding window, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

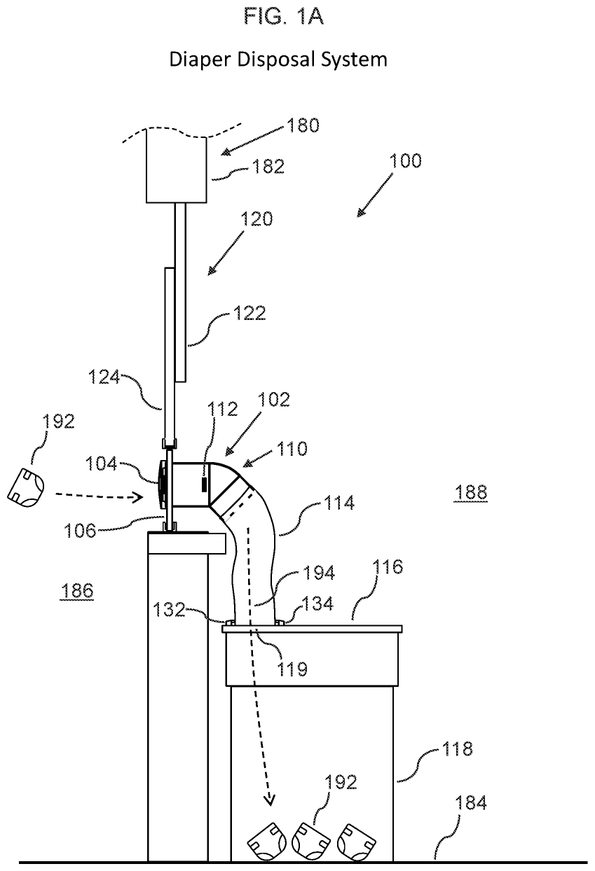

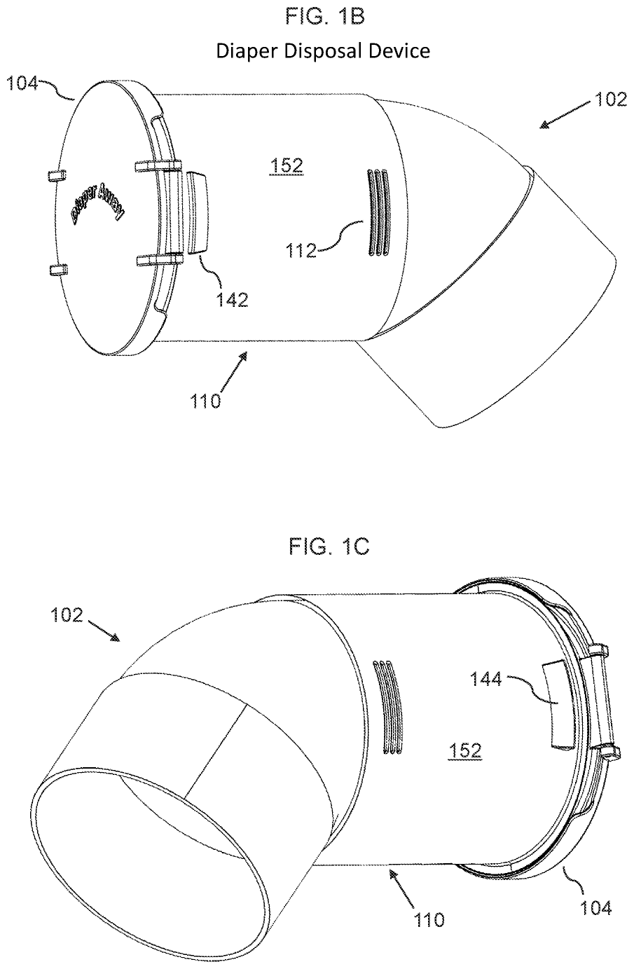

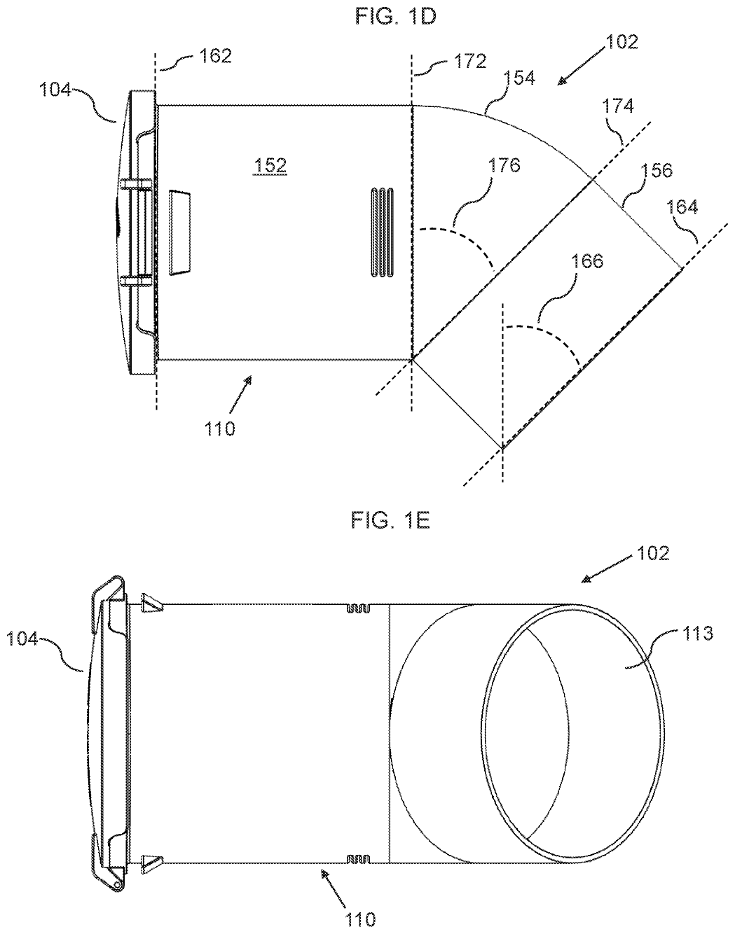

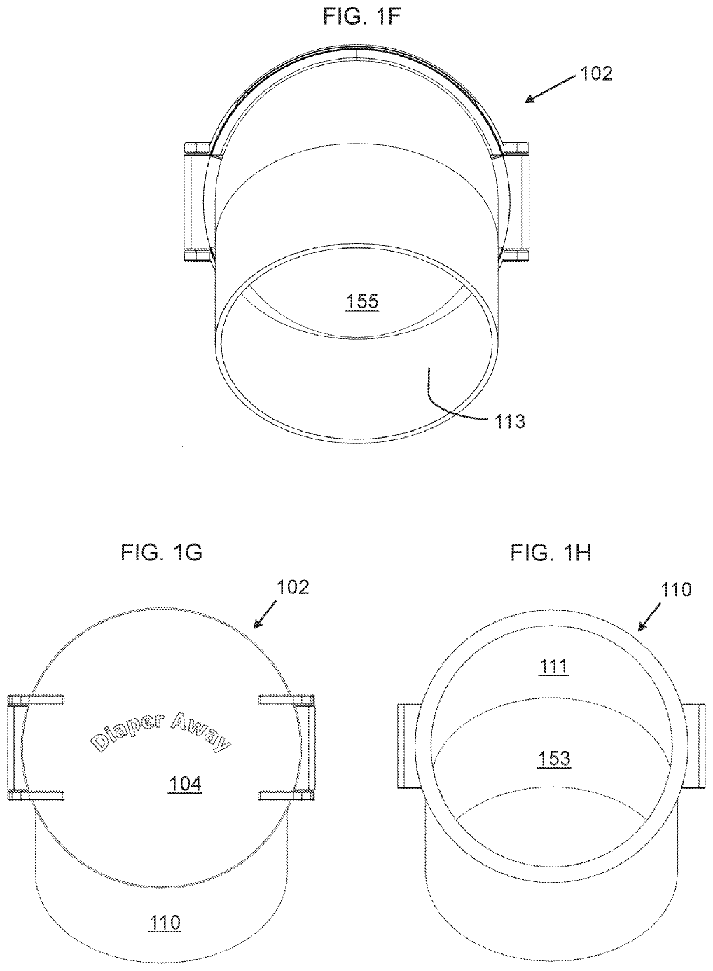

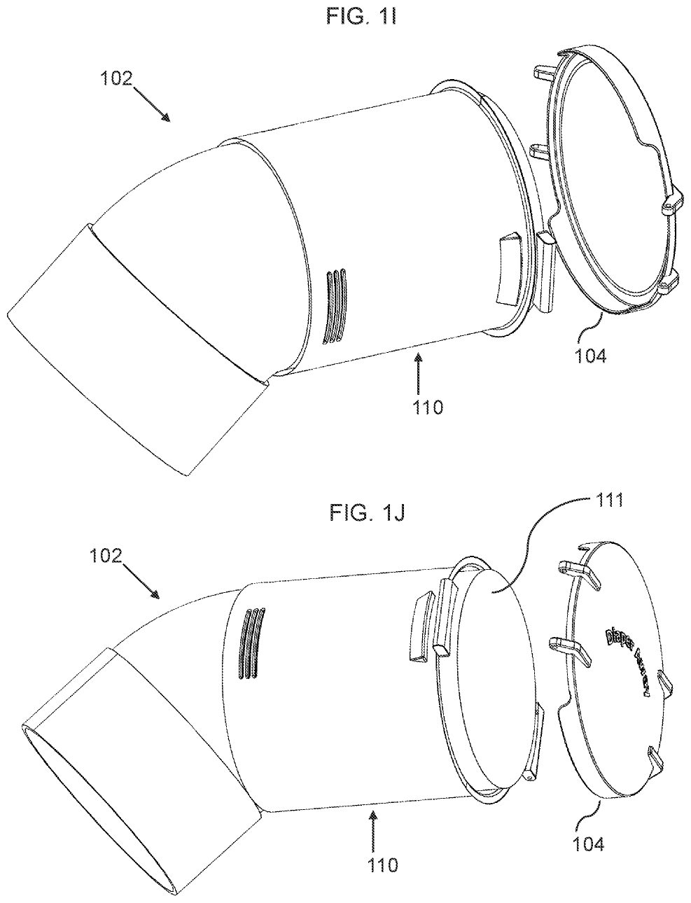

In the following, we describe the structure of an embodiment of a diaper disposal system 100 with reference to FIG. 1A, in such manner that like reference numerals refer to like components throughout; a convention that we shall employ for the remainder of this specification.

In an embodiment, as shown in FIGS. 1A-1J, a diaper disposal system 100 can include:
a) a diaper disposal container 118, which is configured to be positioned in an exterior 188 of a building 180, such as on a ground surface 184 adjacent to the building 180;
b) a diaper disposal device 102, which can include:
   i. an angled chute 110; and
c) a connecting chute 114, which is connected between an exit aperture 113 of the angled chute 110 and an entry aperture 119 of the diaper disposal container 118;
wherein an inner portion of the angled chute 110 is configured to be mounted in a wall of a building 180, such as in a window opening of a window assembly 120 in a wall 182 of the building 180;
such that an entry aperture 111 of the angled chute 110 of the diaper disposal device 102 (as shown in FIGS. 1H and 1J) can be exposed in an interior 186 of the building 180, such that a diaper 192 can be disposed into the entry aperture 111 of the angled chute 110 of the diaper disposal device 102, whereby the diaper 192 can fall through the angled chute 110 and the connecting chute 114, and into the diaper disposal container 118.

In a related embodiment, the connecting chute 114 can be configured as a flexible chute, such as a flexible duct work piece; which is made from a flexible material, which can include a combination of flexible material, included flexible plastic and flexible sheets of plastic, such as polyethylene or polyester. In alternative embodiments the connecting chute can be substantially non-flexible and made from a hard plastic or metal alloy.

In a related embodiment, the diaper disposal system 100 can include an extended connecting chute 114 for windows in a multi-level home and for windows further above the ground.

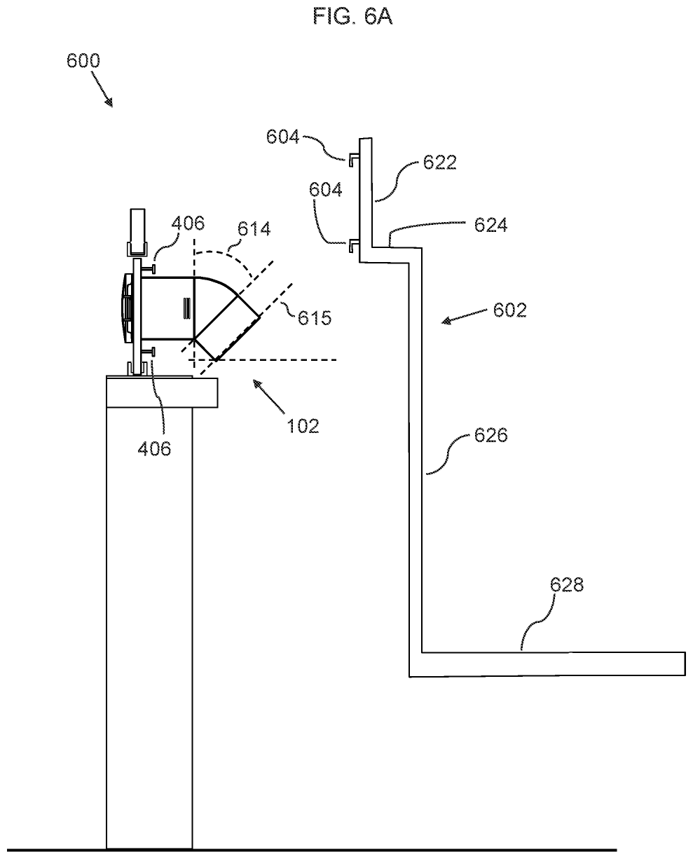

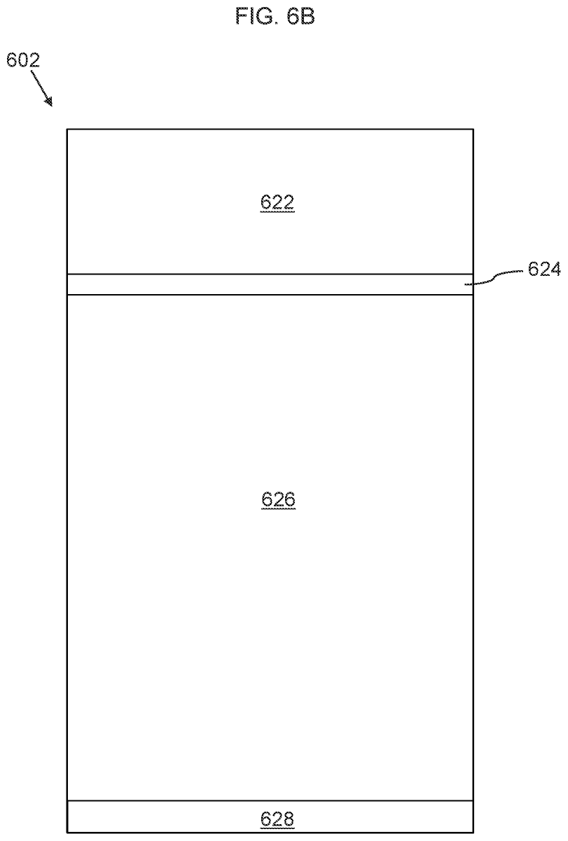

In another related embodiment, as shown in FIGS. 1D and 6A, an entry plane 162 of the entry aperture of the angled chute 110 can be configured to be vertical and an exit plane 164 of the exit aperture of the angled chute 110 can be configured with a downward inclination angle 614 in a range of 5 to 90 degrees (such as for example substantially 45 degrees as shown), when the inner portion of the diaper disposal device 102 is mounted in the window opening.

In a further related embodiment, the exit plane of the exit aperture of the diaper disposal device 102 can be configured to be horizontal when the inner portion of the angled chute is mounted in the window opening, such that the downward inclination angle 614 of the exit plane 164 of the exit aperture of the angled chute 110 is 90 degrees.

In yet another related embodiment, as shown in FIGS. 1D and 6A-6B, the angled chute 110 can further include:
a) an upper body portion 152;
b) a lower body portion 156; and
c) a middle body portion 154, which is connected between the upper body portion 152 and the lower body portion 156;
wherein the middle body portion 154 is configured with a chute inclination angle 176 in a range of 5 to 90 degrees, between an entry plane 172 of an entry aperture 153 of the middle body portion 154 and an exit plane 174 of an exit aperture 155 of the middle body portion 154.

In a further related embodiment, the upper body portion 152 and the lower body portion 156 can each be configured as straight tubular pieces (i.e. substantially tubular with exception of ventilation apertures, handles, etc.); and the middle body portion 154 can be configured a curved tubular piece (i.e. substantially curved tubular with exception of apertures or other features), which can also be described as an angled tubular piece or a bent tubular piece.

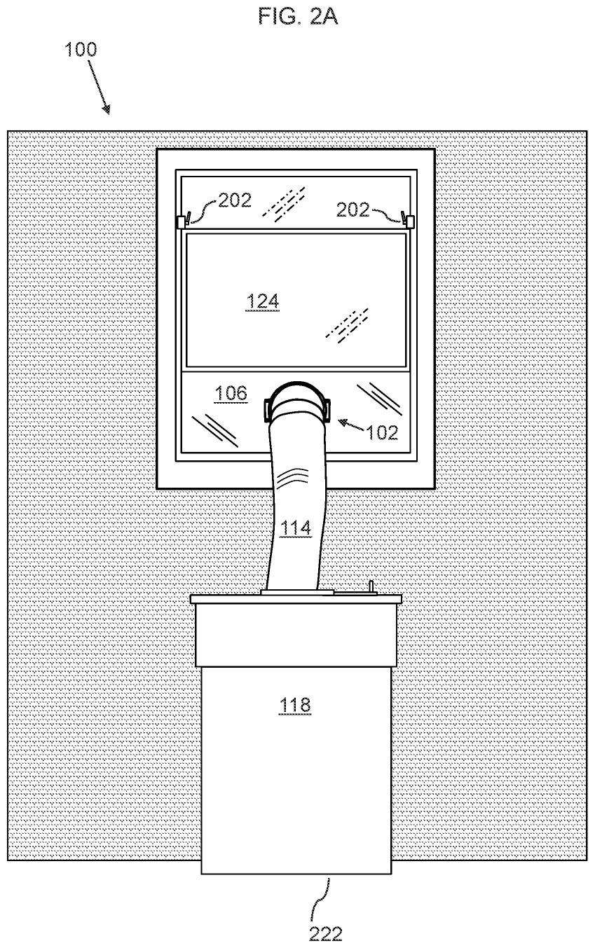

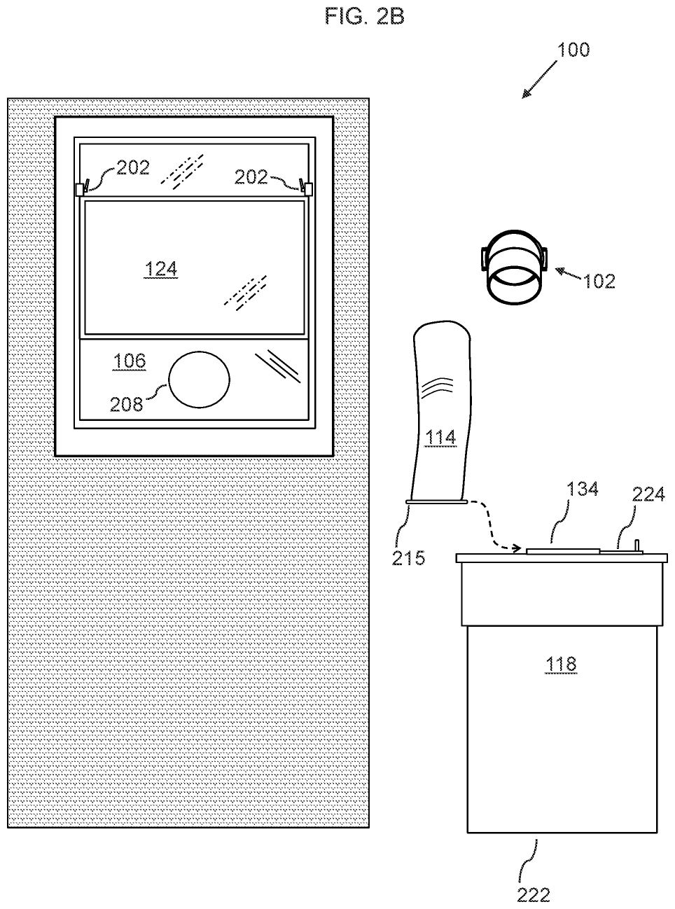

In yet a related embodiment, as shown in FIG. 2B, the diaper disposal container 118 can further include:
a) a container body 222, such that a top surface of the container body is configured with the entry aperture 119 of the diaper disposal container; and
b) a slidable lid 224, which is slidably spring mounted in the top surface of the container body, such that the slidable lid covers the top surface of the container body when the slidable lid is in a closed position;
such that an outer end of the connecting chute 114 is slidably connectable around the entry aperture 119 of the container body 222, such that the slidable lid 224 slides to an open position when the connecting chute 114 is slidably connected, and such that the slidable lid 224 slides back to the closed position when the connecting chute 114 is slidably removed, for example such that a spring mount of the slidable lid 224 ensures that the slidable lid 224 slides back to the closed position. A slidable lid handle 758 can be mounted on a top of the slidable lid 224.

In another related embodiment, as shown in FIGS. 1A, 2B, and 7B, the diaper disposal container 118 can further include:
a) a first guide rail 132, which can be reverse L-shaped, such that a vertical portion 724 is connected to an inward protruding portion 726; and
b) a second guide rail 134, which can be reverse L-shaped, such that a vertical portion 744 is connected to an inward protruding portion 746;
wherein the first guide rail 132 and the second guide rail 134 are mounted in parallel on first and second sides of the entry aperture 119 of the container body 222;
such the slidable lid 224 can be configured to slide between the first guide rail and the second guide rail;
wherein a circumference of the outer end of the connecting chute can be configured with a perpendicular flange 215, such that the perpendicular flange 215 is configured to be slidably connected between the first guide rail 132 and the second guide rail 134.

In yet another related embodiment, as shown in FIGS. 1A and 2B, the diaper disposal system 100 can further include:
a) a window panel 106, which comprises a central aperture 208;
such that the window panel 106 is configured to be mounted in the window opening of the window assembly 120;
such that the inner portion of the diaper disposal device 102 is configured to be mounted in the central aperture 208;
such that the window panel and the inner portion of the diaper disposal device seal the window opening of the window assembly.

In a further related embodiment, the upper body portion 152 of the angled chute 110 of the diaper disposal device 102 can include at least one ventilation aperture 112.

In a yet further related embodiment, the at least one ventilation aperture 112 can be elongated and positioned on a side of the upper body portion 152 of the angled chute 110 of the diaper disposal device 102, such that the at least one ventilation aperture 112 is vertically oriented, when the inner portion is mounted in the window opening.

In another further related embodiment, as shown in FIGS. 1B and 1C, the inner portion of the angled chute 110 can further include:
a) an upper body portion 152;
b) a right protruding handle 142, which is positioned on a right side of the upper body portion 152; and
c) a left protruding handle 144, which is positioned on a left side of the upper body portion 152;
wherein the right protruding handle 142 and the left protruding handle 144 are configured to aid in positioning into and removal from the window opening of the window assembly 120.

In a yet further related embodiment, each of the right protruding handle 142 and the left protruding handle 142 can be elongated and vertically oriented, when the inner portion is mounted in the window opening.

In a related embodiment, as shown in FIGS. 6A-6B, 7A, and 8, the diaper disposal system 100 can further include:
a) a disposal container support member 602, which comprises:
   i. an upper support portion 622;
   ii. a first intermediate support portion 624;
   iii. a second intermediate support portion 626; and
   iv. a lower support portion 628;
wherein the upper support portion 622 of the disposal container support member 602 is configured to detachably attach to the window panel 106; and
wherein a lower support portion 628 of the disposal container support member 602 is configured to support the diaper disposal container 118, such that the diaper disposal container 118 is positionable on the lower support portion 628 of the disposal container support member 602;
wherein the upper support portion 622, the first intermediate support portion 624, the second intermediate support portion 626, and the lower support portion 628 are configured as successively connected plates, as shown in FIG. 2B
such that the upper support portion 622 is vertical and the lower support portion 628 is horizontal when the upper support portion 622 is attached to the window panel 106.

In a further related embodiment, the upper portion of the disposal container support member 602 can further include:
a) support attachment points 604;
wherein the window panel 106 further comprises panel attachment points 406, such that the support attachment points 604 are configured to be detachably attachable to the panel attachment points 406.

In a related embodiment, the diaper disposal device 102 can further include:
a) a lid 104, which is attachable to an inner end of the angled chute, around the entry aperture 111 of the angled chute 110, such that the lid 104 is configured to close an entry aperture 111 of the angled chute 110 of the diaper disposal device 102 (as shown in FIG. 1J);

In a further related embodiment, the lid 104 can be pivotably connected to an inner end of the angled chute 110.

In related embodiments, the diaper disposal system 100 can include a decorative cover 402, e.g., a flower box, that can be engaged with corresponding attachments on the door frame.

In a further related embodiment, the diaper disposal system 100 can include a collar that secures a disposal bag to the second end of the connecting chute 114. In some implementations, the diaper disposal system may include a receptacle with a handle, wherein the receptacle slides into place at the end of the connecting chute 114, such that the connecting chute 114 is in communication with the receptacle, and wherein the receptacle has a slidable top lid. When the receptacle is removed for emptying, the slidable top slides over the opening to lock out odor.

In a further related embodiment, the second end of the angled chute can be in direct communication with the receptacle.

In an embodiment, FIG. 1A shows a side view of a diaper disposal system 100. The figure illustrates a side cut through of a vertically slidable lower window pane 124 and an upper window pane 122. The system can include window panel 106, which includes a panel aperture 208 (shown in FIG. 2B), such that an inner portion of the diaper disposal device 102 can penetrate through the panel aperture 208 of the window panel 106. In some embodiments the window panel 106 can include a lid and which can be hingedly connected. The angle chute includes a plumbing vent 112. The angled chute 110 can be in communication with a connecting chute 114. The connecting chute 114 can be in communication with a diaper disposal pail 118, wherein the pail includes a lid 116.

In a related embodiment, FIG. 2A shows an exterior view of a diaper disposal system 100 in accordance with some related embodiments. The vertically slidable lower window pane 124 can be prevented from being opened further by locking stoppers 202 to help improve security for the window where the disposal system 100 is placed.

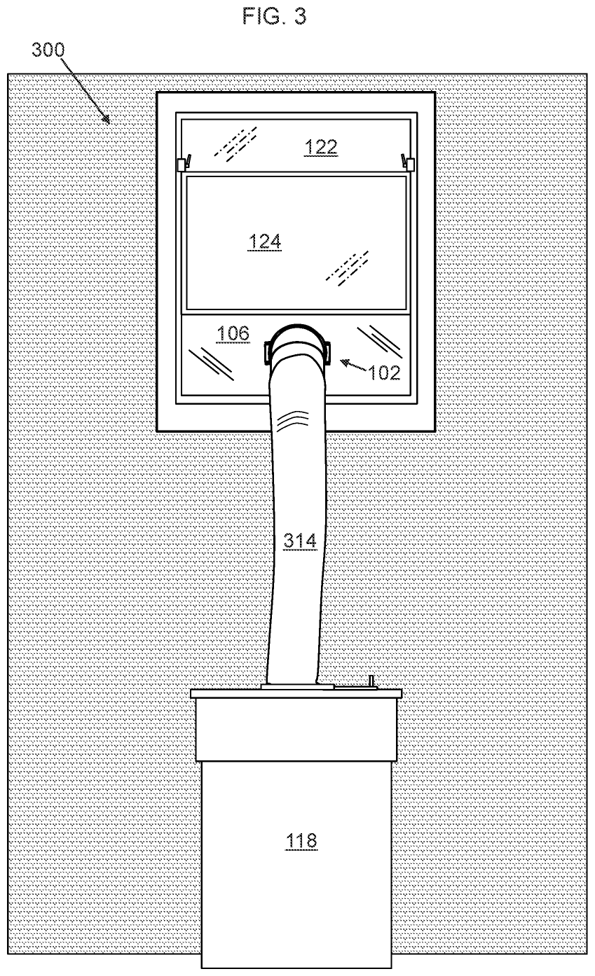

In a related embodiment, FIG. 3 shows an outside view of a diaper disposal system 300 mounted in a second-story window in accordance with some related embodiments. The diagram shows the use of an extended connecting chute 314 in the diaper disposal system 100, when the system is installed in a second-story window or a window further above the ground.

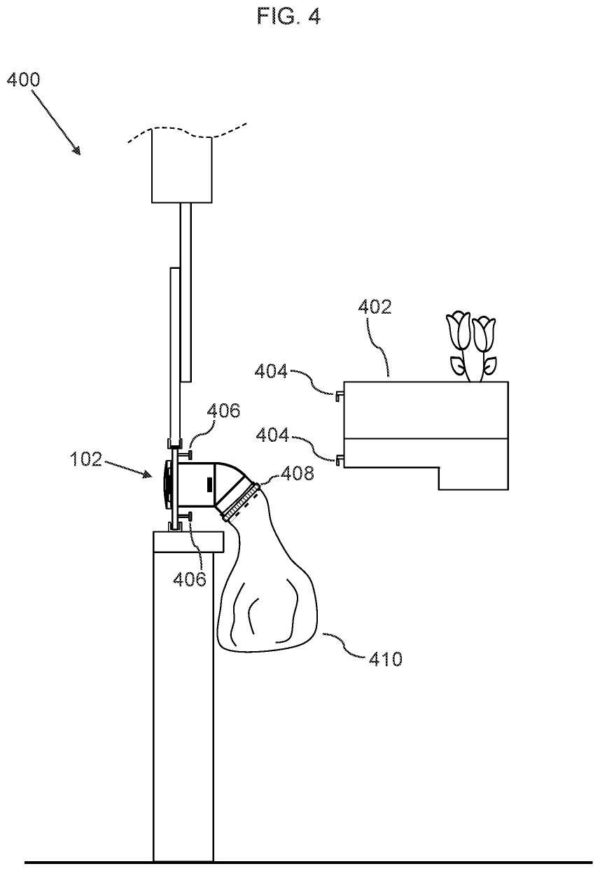

In a related embodiment, FIG. 4 shows a side view of an example diaper disposal system 400 with disposal bag and flower box concealment, in accordance with some related embodiments. The flower box 402 can include attachment points 404 that engage with corresponding attachment points 406 on the door support frame 106. The diagram illustrates another related embodiment, wherein the connecting chute 114 can be in communication with a disposal bag 410, wherein a collar 408 secures the disposal bag 410 to the connecting chute 114 by slipping over the open end of the disposal bag and securing the disposal bag in place via an interference fit between the chute member 114 and the collar 408.

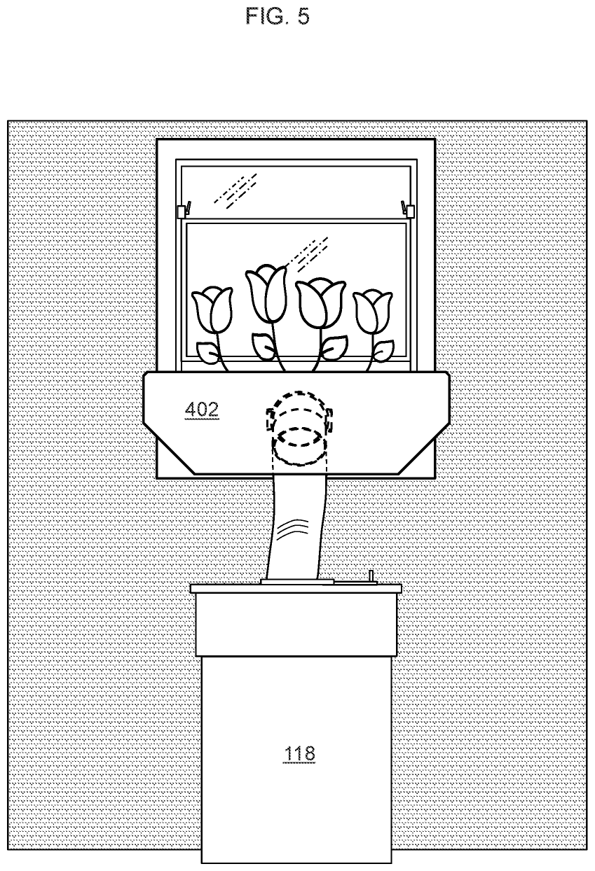

In a related embodiment, FIG. 5 shows a diagram showing an exterior view of the flower box concealment 402, in accordance with some related embodiments.

In a related embodiment, FIG. 6A shows a side view of an example diaper disposal system 600 with a disposal container support member 602, in accordance with some related embodiments. In this embodiment of the diaper disposal system 100, a disposal container support member 602, with attachment points 604 can engage with the corresponding attachment points 406 on the door frame support 106.

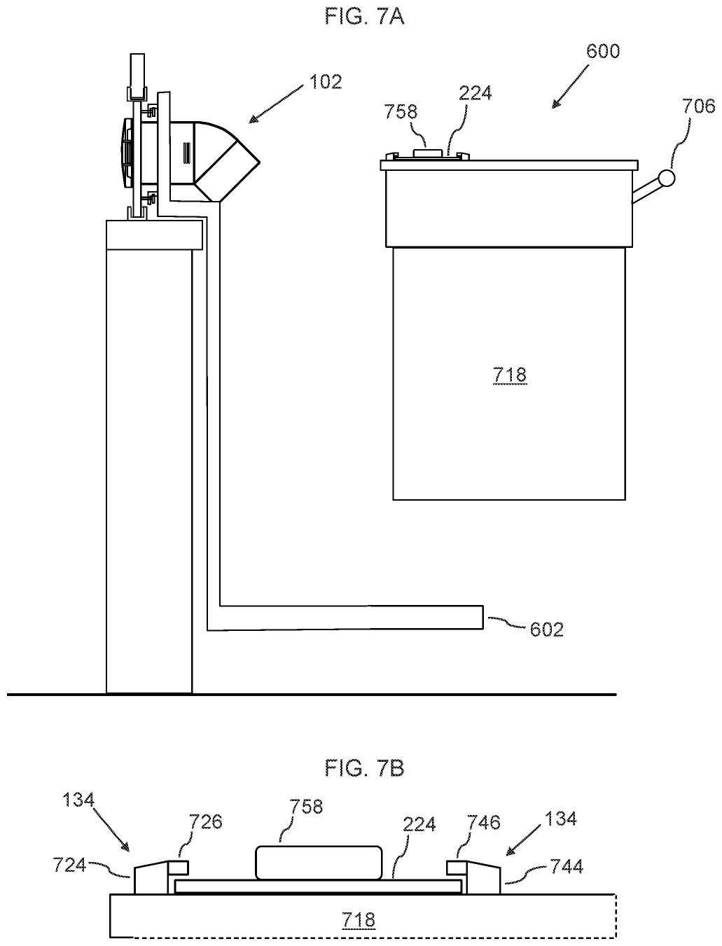

In a related embodiment, FIG. 7A shows a side view of an example diaper disposal system 600 with a removable disposal container, in accordance with some related embodiments. A disposal container 718, with a slidable top lid 224 and handle 706, can be configured to slide onto the disposal container support member 602. As the disposal container 718 slides into place, the top lid 224 slides in the direction of the handle 706 enabling the angled chute 110, in this example diagram, to communicate with the disposal container 718.

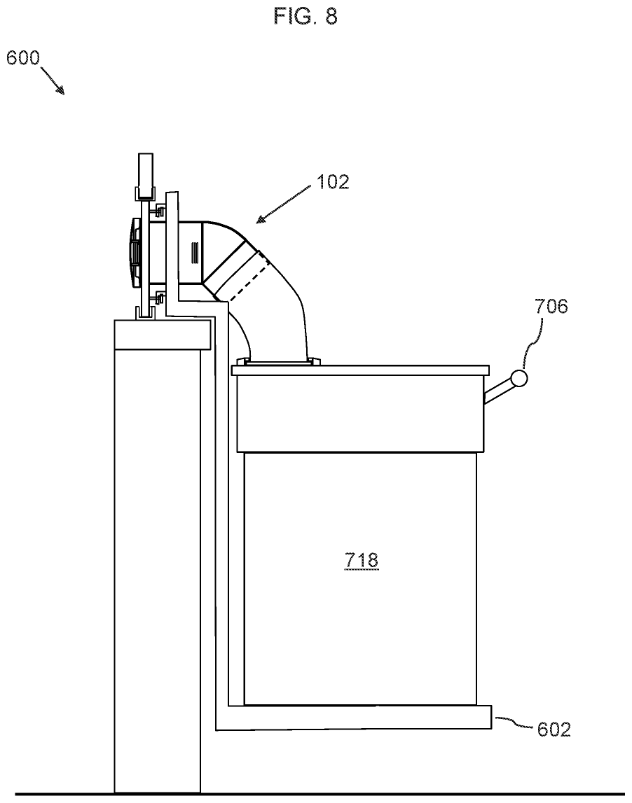

FIG. 8 shows a side view of an example diaper disposal system 600 with a removable disposal container 718, in accordance with some related embodiments. The disposal container 718 is illustrated to be in place, on the disposal container support member 602, wherein the angled chute 110 is in communication with the disposal container 718. In another embodiment, the angled chute 110 may be in communication with a connecting chute 114, or an extended connecting chute 314, (e.g., as shown in FIG. 1A or 3) wherein the connecting chute 114 or the extended connecting chute 314 is in communication with the disposal container 718.

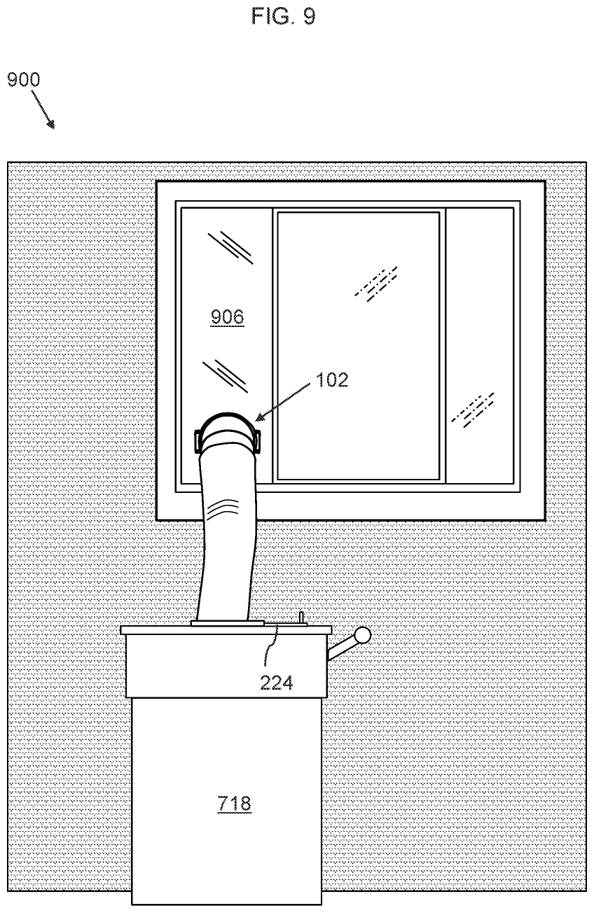

In a related embodiment, FIG. 9 shows a diaper disposal system 900 which includes a vertical window panel 906. In this example implementation of an exterior diaper disposal system, a diaper disposal container is illustrated. In other implementations, a bag 410 or slidable disposal container 718 may be used.

Thus, in various related embodiments, a diaper disposal system 100 can include:
a) an upper section that includes a door opening for disposing of diaper waste, wherein the door opening is secured to a door frame that is held in place with a door frame support, wherein the door frame is configured to be installed between a slidable window and a window frame;
b) a middle section that includes an angled chute and a connecting chute 114, wherein the angled chute 110 has a first end in communication with the door, and a second end in communication with a first end of the connecting chute 114; and
c) a lower section that includes a container that receives and stores diaper waste, wherein the container has an opening for receiving diaper waste, and wherein the container is placed adjacent to a house exterior, and wherein the opening of the container is in communication with the second end of the connecting chute 114.

In a related embodiment, the diaper disposal system 100 can further include:
a) a door opening for disposing waste into a container;
b) a door frame that is held in place with a door frame support, wherein the door frame is configured to be installed between a slidable window and a window frame;
c) an angled chute that has a first end in communication with the door via a coupler, and a second end in communication with a first end of a connecting chute 114; and
d) a container for waste having an opening for receiving waste, wherein the container is placed adjacent to a house exterior, and wherein the opening of the container is in communication with a second end of the connecting chute 114.

Thus, in various related embodiments of the diaper disposal system 100, a container receives and stores large amounts of soiled diapers or other waste such as food scraps outside a house through a chute connected to a window in a house. The container receives a soiled item through a door opening on the window. The door opening is held in place by a door frame, which is configured to be installed between a slidable window pane and a window frame. An angled chute 110 connects the door to a connecting chute 114, and the connecting chute 114 connects to the container, placed outside the house

Some further related embodiments of the diaper disposal system 100 can include an exterior diaper disposal system comprising a door opening for disposing of soiled diapers, wherein the door opening is secured to a door frame that is held in place with a door frame support. The door frame sits between a slidable window and a window frame. The door opening is in communication with a first end of an angled chute via a coupler, outside the window, wherein a second end of the angled chute is in communication with a first end of a connecting chute 114. A second end of the connecting chute 114 is in communication with a container that receives and holds the soiled diapers or food scraps for composting. The angled chute of the diaper disposal system includes a vent to permit the supply of fresh air to the disposal system and removal of odors or vapors from the solid diapers in the container.

Here has thus been described a multitude of embodiments of the diaper disposal system 100 and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A diaper disposal system, comprising:
a) a diaper disposal container, which is configured to be positioned in an exterior of a building;
b) a diaper disposal device, which comprises:
an angled chute; and
c) a connecting chute, which is connected between an exit aperture of the angled chute and an entry aperture of the diaper disposal container;
wherein an inner portion of the angled chute is configured to be mounted in a window opening of a window assembly in a wall of the building, such that an entry aperture of the angled chute is exposed in an interior of the building, such that a diaper is disposable into the entry aperture of the angled chute, whereby the diaper falls through the angled chute and the connecting chute, and into the diaper disposal container.

2. The diaper disposal system of claim 1, wherein an entry plane of the entry aperture of the angled chute is configured to be vertical and an exit plane of the exit aperture of the angled chute is configured with a downward inclination angle in a range of 5 to 90 degrees, when the inner portion of the angled chute is mounted in the window opening.

3. The diaper disposal system of claim 2, wherein the exit plane of the exit aperture of the angled chute is configured to be horizontal when the inner portion of the angled chute is mounted in the window opening, such that the downward inclination angle of the exit plane of the exit aperture of the angled chute is 90 degrees.

4. The diaper disposal system of claim 1, wherein the angled chute further comprises:
a) an upper body portion;
b) a lower body portion; and
c) a middle body portion, which is connected between the upper body portion and the lower body portion;
wherein the middle body portion is configured with a chute inclination angle in a range of 5 to 90 degrees, between an entry plane of an entry aperture of the middle body portion and an exit plane of an exit aperture of the middle body portion.

5. The diaper disposal system of claim 4, wherein the upper body portion and the lower body portion are each configured as straight tubular pieces;
and the middle body portion is configured as a curved tubular piece.

6. The diaper disposal system of claim 1, wherein the connecting chute is configured as a flexible chute, which is made from a flexible material.

7. The diaper disposal system of claim 1, wherein the diaper disposal container further comprises:
a) a container body, such that a top surface of the container body comprises the entry aperture of the diaper disposal container; and
b) a slidable lid, which is slidably mounted in the top surface of the container body, such that the slidable lid covers the top surface of the container body when the slidable lid is in a closed position;
such that an outer end of the connecting chute is slidably connectable around the entry aperture of the container body, such that the slidable lid slides to an open position when the connecting chute is slidably connected, and such that the slidable lid slides back to the closed position when the connecting chute is slidably removed.

8. The diaper disposal system of claim 7, wherein the diaper disposal container further comprises:
a) a first guide rail; and
b) a second guide rail;
wherein the first guide rail and the second guide rail are mounted in parallel on first and second sides of the entry aperture of the container body;
such the slidable lid is configured to slide between the first guide rail and the second guide rail;
wherein a circumference of the outer end of the connecting chute is configured with a perpendicular flange, such that the perpendicular flange is configured to be slidably connected between the first guide rail and the second guide rail.

9. The diaper disposal system of claim 1, further comprising:
a window panel, which comprises a central aperture;
such that the window panel is configured to be mounted in the window opening of the window assembly;
such that the inner portion of the diaper disposal device is configured to be mounted in the central aperture; and
such that the window panel and the inner portion of the diaper disposal device seal the window opening of the window assembly.

10. The diaper disposal system of claim 4, wherein the upper body portion comprises at least one ventilation aperture.

11. The diaper disposal system of claim 10, wherein the at least one ventilation aperture is elongated and positioned on a side of the upper body portion, such that the at least one ventilation aperture is and vertically oriented, when the inner portion is mounted in the window opening.

12. The diaper disposal system of claim 1, wherein the inner portion of the angled chute further comprises:
a) an upper body portion;
b) a right protruding handle, which is positioned on a right side of the upper body portion; and
c) a left protruding handle, which is positioned on a left side of the upper body portion;
wherein the right protruding handle and the left protruding handle are configured to aid in positioning into and removal from the window opening of the window assembly.

13. The diaper disposal system of claim 12, wherein each of the right protruding handle and the left protruding handle are elongated and vertically oriented, when the inner portion is mounted in the window opening.

14. The diaper disposal system of claim 9, further comprising:
a disposal container support member, which comprises:
an upper support portion; and
a lower support portion;
wherein the upper support portion of the disposal container support member is configured to attach to the window panel; and
wherein the lower support portion of the disposal container support member is configured to support the diaper disposal container, such that the diaper disposal container is positionable on the lower support portion of the disposal container support member.

15. The diaper disposal system of claim 14, wherein the disposal container support member further comprises:
a first intermediate support portion; and
a second intermediate support portion;
wherein the upper support portion, the first intermediate support portion, the second intermediate support portion, and the lower support portion are configured as successively connected plates;
such that the upper support portion is vertical and the lower support portion is horizontal when the upper support portion is attached to the window panel.

16. The diaper disposal system of claim 14, wherein the upper support portion of the disposal container support member further comprises:
support attachment points;
wherein the window panel further comprises panel attachment points, such that the support attachment points are configured to be detachably attachable to the panel attachment points.

17. The diaper disposal system of claim 1, wherein the diaper disposal device further comprises:
a lid, which is detachably connected to an inner end of the angled chute, around the entry aperture of the angled chute.

18. The diaper disposal system of claim 17, wherein the lid is pivotably connected to the inner end of the angled chute.

19. A diaper disposal system, comprising:
a diaper disposal device, which comprises:
an angled chute;
wherein an inner portion of the angled chute is configured to be mounted in a window opening of a window assembly in a wall of a building, such that an entry aperture of the angled chute is exposed in an interior of the building, such that a diaper is disposable into the entry aperture of the angled chute, whereby the diaper falls through the angled chute to an exterior of the building.

20. The diaper disposal system of claim 19, further comprising:
a connecting chute, which is configured to be connected between an exit aperture of the angled chute and an entry aperture of a diaper disposal container;
whereby the diaper falls through the angled chute and the connecting chute, and into the diaper disposal container.

21. The diaper disposal system of claim 20, further comprising:
the diaper disposal container, which is configured to be positioned in the exterior of the building.

22. The diaper disposal system of claim 19, wherein an entry plane of the entry aperture of the angled chute is configured to be vertical and an exit plane of an exit aperture of the angled chute is configured with a downward inclination angle in a range of 5 to 90 degrees, when the inner portion of the angled chute is mounted in the window opening.

23. The diaper disposal system of claim 21, wherein the diaper disposal container further comprises:
a) a container body, such that a top surface of the container body is configured with the entry aperture of the diaper disposal container; and
b) a slidable lid, which is slidably mounted in the top surface of the container body, such that the slidable lid covers the top surface of the container body when the slidable lid is in a closed position;
such that an outer end of the connecting chute is slidably connectable around the entry aperture of the container body, such that the slidable lid slides to an open position when the connecting chute is slidably connected, and such that the slidable lid slides back to the closed position when the connecting chute is slidably removed.

24. The diaper disposal system of claim 23, wherein the diaper disposal container further comprises:
a) a first guide rail; and
b) a second guide rail;
wherein the first guide rail and the second guide rail are mounted in parallel on first and second sides of the entry aperture of the container body;
such the slidable lid is configured to slide between the first guide rail and the second guide rail;
wherein a circumference of the outer end of the connecting chute is configured with a perpendicular flange, such that the perpendicular flange is configured to be slidably connected between the first guide rail and the second guide rail.

25. The diaper disposal system of claim 20, further comprising:
a window panel, which comprises a central aperture;
such that the window panel is configured to be mounted in the window opening of the window assembly;
such that the inner portion of the diaper disposal device is configured to be mounted in the central aperture; and
such that the window panel and the inner portion of the diaper disposal device seal the window opening of the window assembly.

26. The diaper disposal system of claim 19, wherein the inner portion of the angled chute further comprises:
a) an upper body portion;
b) a right protruding handle, which is positioned on a right side of the upper body portion; and
c) a left protruding handle, which is positioned on a left side of the upper body portion;
wherein the right protruding handle and the left protruding handle are configured to aid in positioning into and removal from the window opening of the window assembly.

27. The diaper disposal system of claim 25, further comprising:
a disposal container support member, which comprises:
an upper support portion; and
a lower support portion;
wherein the upper support portion of the disposal container support member is configured to attach to the window panel; and
wherein the lower support portion of the disposal container support member is configured to support the diaper disposal container, such that the diaper disposal container is positionable on the lower support portion of the disposal container support member.

28. The diaper disposal system of claim 27, wherein the upper support portion of the disposal container support member further comprises:
support attachment points;
wherein the window panel further comprises panel attachment points, such that the support attachment points are configured to be detachably attachable to the panel attachment points.
